(19) United States
(12) Patent Application Publication
(10) Pub. No.: US 2008/0187691 A1
(43) Pub. Date: Aug. 7, 2008

(54) Rapid Ink Drying Papers

(75) Inventors: Alonzo K. Osgood, Portland, ME (US); Steven L. Masia, Westbrook, ME (US); Daniel R. Coughlin, Falmouth, ME (US); Phillip S. Coleman, Standish, ME (US)

Correspondence Address: FISH & RICHARDSON PC, P.O. BOX 1022, MINNEAPOLIS, MN, 55440-1022, US

(73) Assignee: S.D. WARREN COMPANY, Boston, MA (US)

(21) Appl. No.: 11/672,156

(22) Filed: Feb. 7, 2007

(51) Int. Cl. B41M 5/50; B41M 5/00

(52) U.S. Cl. 428/32.32; 428/32.1; 428/32.34; 428/32.35

(57) ABSTRACT

Papers are provided which exhibit rapid ink setting and ink drying. These papers include a topcoat layer, and a penultimate coating layer that draws ink through the topcoat layer. In some implementations, the penultimate coating layer includes a high internal pore volume filler, and/or has a fine external pigment pore structure.

### TECHNICAL FIELD

This invention relates to rapid ink drying printing and publishing papers.

### BACKGROUND

In offset printing, it is important that the ink sets rapidly, followed very quickly by the ink drying. Ink setting refers to the ink reaching a stage where it will not smudge when printing the second side, while ink drying occurs when the resin binder of the ink is sufficiently chemically cross-linked and bonded to the substrate such that when the ink film is dry it can withstand typical post-printing processing, such as trimming, folding and binding, without disturbance of the ink film.

It is also important that the printed image exhibit high ink gloss and good printability, characterized by low print mottle, low backtrap mottle, good ink film uniformity, low water interference mottle and accurate color trapping. There is a perceived trade-off between rapid ink-setting and good ink gloss, such that fast ink setting leads to low ink gloss and increased print mottle and slow ink setting leads to high ink gloss and decreased print mottle.

### SUMMARY

The disclosure herein features papers that exhibit rapid ink setting, followed by rapid ink drying, while maintaining high ink gloss. Preferred papers, when printed, provide a good printed appearance with regard to print mottle, backtrap mottle, ink film continuity, water interference mottle and accurate color trapping.

In one aspect, the invention features a paper comprising: a basesheet, a penultimate coating layer, and a porous topcoat disposed directly adjacent the penultimate coating layer and having a surface exposed to receive a printed image. The penultimate coating layer is configured to draw ink vehicle through the topcoat.

Some implementations include one or more of the following features. The penultimate coating may include a filler having a high internal pore volume. The penultimate coating layer may have an external pigment peak mean pore diameter finer than 0.20 μm, e.g., finer than 0.10 μm. The penultimate coating layer may include up to 30% of the high internal pore volume (HIP) filler. The HIP filler is selected from the group consisting of synthetic amorphous silica gels, synthetic calcium silicate, synthetic silicon dioxide, calcined clay, porous calcium carbonate, and mixtures thereof. The HIP filler may also comprise a particulate material that creates micro-pores in the coating by interaction of the particulate material with itself or other materials in the coating. The filler may have an internal pore volume of at least 1.2 ml/gram. The penultimate coating layer may comprise a pigment or pigment blend having an overall particle size distribution such that about 25% of the particles are finer than 0.2 μm, about 50% of the particles are finer than 0.5 μm, and about 70% of the particles are finer than 2 μm. For example, the penultimate coating layer may comprise a blend of pigments having different particle size distributions, the pigments being selected and provided in relative proportions so as to provide the overall particle size distribution. The penultimate coating layer may in some cases include a component having high ink vehicle interactivity.

The topcoat may comprise a pigment or pigment blend having an overall particle size distribution such that about 20% of the particles are finer than 0.2 μm, about 60% of the particles are finer than 0.5 μm, and 95% of the particles are finer than 2 μm. The topcoat may comprise a blend of pigments having different particle size distributions, the pigments being selected and provided in relative proportions so as to provide the overall particle size distribution. The topcoat may have an external pigment pore structure with a peak mean pore diameter finer than about 0.12 μm, preferably finer than about 0.1 μm, e.g., about 0.05 to 0.08 μm. The topcoat is preferably substantially free of ink vehicle absorbent materials.

In another aspect, the invention features a paper comprising: a basesheet; a penultimate coating layer comprising (a) an HIP filler; and (b) a pigment or pigment blend having an overall particle size distribution such that about 25% of the particles are finer than 0.2 μm, about 50% of the particles are finer than 0.5 μm, and about 70% of the particles are finer than 2 μm; and a porous topcoat, disposed directly adjacent the penultimate coating layer and having a surface exposed to receive a printed image.

In preferred implementations, the pore size of the topcoat is controlled so as to allow leveling of the ink resins and pigments at the surface of the paper while facilitating draining of the ink vehicle. This pore structure of the topcoat delays the initial ink setting of the ink while the ink levels, providing good printability. When the ink vehicle penetrates to the penultimate fast ink setting and drying will occur. It is the creation of a large fluid dynamic potential, incorporating both thermodynamic and pressure gradient potentials, in the penultimate coating that drives movement of the ink vehicle from the topcoat into the penultimate coating. To obtain excellent printability (characterized by high ink gloss and low print mottle), while setting and drying the ink quickly, the topcoat is designed to act as a semi-permeable membrane with the pore structure being configured to delay ink vehicle drainage long enough to give the ink resins and ink pigments time to level, but not so long as to overly delay the setting and drying (cross-linking of resins) of the ink resins in the penultimate coating.

In preferred implementations, the fluid dynamic (both pressure and thermodynamic gradients) potential of the penultimate coating is controlled by three factors: (1) appropriate capillary size of the penultimate coating (as controlled by the pore structure of the penultimate coating), (2) a high internal volume available to absorb the ink vehicle, e.g., provided by high internal pore volume (HIP) fillers in the penultimate coating, and (3) chemically driven absorption, facilitated by matching the solubility parameter of the penultimate coating binder or other chemicals to the solubility parameter of the ink vehicle. Through control of all three of these parameters in the penultimate coating and application of the properly balanced topcoat it is possible to maintain high ink gloss, good printability and rapid ink setting, which will result in rapid ink drying of the ink resins as facilitated by oxidation when the ink vehicle is removed.

Preferred papers exhibit a good balance of fast ink setting and rapid drying, combined with high ink gloss. In some implementations, ink setting occurs in 10 to 30 minutes, and ink drying occurs in less than 2 hours from printing (ASTM F2498-05), and the printed papers exhibit 20 degree print gloss of at least 40 (ISO 8254-3:2004), low print mottle and good ink film continuity. Advantageously, because the inks exhibit rapid ink setting, in many cases the paper can be printed on the second side and then post-press processed (binding, folding, trimming, etc.) during a single shift, resulting in economical and efficient offset print runs. Because ink setting occurs prior to ink drying, the printed image is stable as soon as it is set and will exhibit the same scuff resistance during subsequent processing as conventional paper-ink systems which have been dried overnight. Additionally, the printer may gain other economic advantages such as using less offset powder, performing cleaning shutdowns less frequently, and reducing or eliminating the need for overcoats for protection of the ink film during post production steps.

The details of one or more embodiments of the invention are set forth in the accompanying drawings and the description below. Other features and advantages of the invention will be apparent from the description and claims.

### DETAILED DESCRIPTION

Unless otherwise specified, all percentages given herein are percent by weight, on a solids basis, based on the total weight of the coating composition.

Preferred papers include a basesheet, and a topcoat and a penultimate coating disposed on the basesheet. The phrase “penultimate coating,” as used herein, refers to the coating immediately below the topcoat. If desired, one or more pre-coatings may be disposed on the basesheet, between the basesheet and the penultimate coating. The topcoat and penultimate coating may be applied using any suitable method, for example using a gated roll coater, metered size press, rod, rigid bevel blade, bent blade, or by curtain coating. The penultimate coating is configured to rapidly absorb ink vehicle from the topcoat (i.e., the penultimate coating exhibits good ink vehicle absorption), while the capillary structure of the topcoat promotes rapid ink vehicle transfer to the penultimate layer. The topcoat pore structure is selectively permeable, such that it does not promote ink pigment or ink resin absorption through the topcoat into the penultimate coating layer. Without wishing to be bound by theory, the inventors believe that ink drying is accelerated by the exposure of the ink resin (remaining on the surface of the topcoat layer) to more oxygen when the ink vehicle is drawn into the paper by the penultimate coating layer.

As discussed above, three factors in the penultimate coating contribute to achieving good vehicle transport: (1) appropriate capillary size of the penultimate coating (as controlled by the external pigment pore structure of the penultimate coating), (2) a high internal volume available to absorb the ink vehicle, e.g., provided by high internal pore volume (HIP) fillers in the penultimate coating, and (3) chemically driven absorption, facilitated by matching the solubility parameter of the penultimate coating binder to the solubility parameter of the ink vehicle. Also critical to high ink gloss and good printability with rapid ink drying is the proper capillary action of the topcoat provided by its pore structure.

Generally, the most significant of these three factors is the internal volume of the penultimate coating that is available for absorption of the ink vehicle. This internal volume is achieved by including in the penultimate coating an internally porous particulate material having a high internal pore volume. Such materials are referred to herein as high internal pore volume (HIP) fillers. Examples of suitable HIP fillers include synthetic amorphous silica gels, synthetic calcium silicate, synthetic silicon dioxide, calcined clay, porous calcium carbonate, or materials that create micro-pores in the coating by their interaction with themselves or other materials in the coating, and mixtures thereof.

The external pigment pore structure of the penultimate coating is provided by including in the penultimate coating one or more pigment(s), each pigment having an average particle size and particle size distribution that is selected to provide the penultimate coating with a desired pore structure and attendant capillary action. It is generally preferred that the external pigment peak pore structure be very fine, i.e., that the coating have an external pigment pore structure with a peak mean pore diameter of less than 0.20 μm, preferably less than 0.15 μm and more preferably less than 0.1 μm. The external pigment pore structure and peak mean pore diameter of the coating may be measured and characterized by mercury porosimetry. The peak mean pore diameter is the peak of the log differential volume (ml/g) of the pore structure of a coating as a function of the pore diameter of the coating as measured on a mercury porosimeter.

As noted above, the chemically driven absorption provided by the penultimate coating is facilitated by matching the solubility parameter of the penultimate coating binder to the solubility parameter of the ink vehicle, as will be discussed in detail below.

To optimize ink set time, ink drying and print characteristics, it is generally preferred that all three of the factors listed above be optimized. However, depending on the ink vehicle transport and absorption requirements for a particular printing application, in some cases only one or two of these factors need be optimized, for example the penultimate coating may have a high internal pore volume for absorption of ink vehicle and a good external pigment peak pore structure, but relatively low ink vehicle interactivity. We will now discuss each of these factors in further detail.

Preferred penultimate coating formulations include (a) one or more HIP filler(s), to provide internal pore volume as discussed above, (b) one or more pigment(s) having average particle size and particle size distribution selected to provide the desired capillary size, as reflected by the external pigment peak pore structure, and (e) a binder system selected to act as a matrix for the filler and pigments and bond the coating to the paper. The binder, and/or other chemicals in the coating formulation, may be selected to exhibit good interactivity with ink vehicles.

HIP fillers are fillers which have an internal pore volume greater than 0.8 ml/gram. Some preferred HIP fillers have an internal pore volume greater than 1.2 ml/gram, measured by nitrogen porosimetry, and some have an internal pore volume of 1.8 or more. The surface area of such fillers is significantly greater than the surface area of a filler of the same particle size without internal porosity. For example, an HIP filler having an average particle size in the range of 3 to 6 μm may have a surface area of about 150 to 400 m²/gram. Generally, preferred HIP fillers exhibit oil absorption of at least 75 grams oil per 100 grams pigment, e.g., 300 g oil/100 g pigment or more. Suitable HIP fillers are available, for example from W.R. Grace & Co. under the tradename SYLOID, and from Millennium Chemicals, Inc., under the tradename SILCRON. Also considered as HIP fillers are particulate materials that create micro-pores in a coating by interacting with themselves or other coating materials, thereby greatly increasing the pore structure of the coating. Such materials include highly modified precipitated calcium carbonate fillers, for example those commercially available from Specialty Minerals Inc. under the tradename JETCOAT precipitated calcium carbonate pigments.

The penultimate coating contains a sufficient amount of the one or more HIP filler(s) to provide the desired rate and degree of vehicle transport and absorption, and thus the desired ink setting and ink drying rates. The concentration of the HIP filler that is necessary will also depend on the extent to which the other two factors discussed above (external pigment pore structure and chemical interactivity) are optimized. If the penultimate coating has a very fine external peak mean pore diameter (less than 0.1 μm) and sufficient volume, and/or the chemistry of the penultimate coating is highly interactive with the ink vehicle, generally a relatively low concentration of HIP filler will provide good vehicle transport, while if the external peak mean pore diameter is coarser with low volume and/or the penultimate coating is less interactive with the ink vehicle, more HIP filler will be needed to obtain the same rate of vehicle transport and absorption. Preferably, the penultimate coating contains at least 3% of the HIP filler, more preferably at least 8%, and most preferably at least 15%. Generally, a concentration of 5% to 20% of the HIP filler will provide adequate vehicle transport and absorption for most applications, with amounts toward the higher end of the range (e.g., 10 to 20%) being preferred if the external peak mean pore diameter is coarse and amounts toward the lower end of the range (e.g., 3 to 10%) being preferred if the external peak mean pore diameter is fine.

A fine external peak mean pore diameter can be obtained by including in the penultimate coating a mixture of pigments having different average particle sizes and particle size distributions, including (a) a large proportion of an ultrafine pigment, i.e., a pigment having a particle size distribution in which at least 30%, and preferably at least 50%, of the particles are finer than 0.2 μm and 96% are less than 2.0 μm as measured by the Sedigraph settling equivalent spherical diameter technique; and smaller proportions of (b) a fine pigment (90% of the particles are finer than 2 μm and 10-40% are finer than 0.2 μm); and (c) a coarse pigment (20-60% of the particles are finer than 2 μm and 0% are finer than 0.2 μm. Preferred pigment mixtures include from 20 to 100% by weight of the ultrafine pigment, 0 to 60% by weight of the fine pigment, and 0 to 40% by weight of the coarse pigment, based on the total weight of the pigment mixture. It is particularly preferred that the relative proportions of the pigments be selected (i.e., that the pigment mixture be formulated) so that the penultimate coating will exhibit an external peak mean pore diameter in the 0.05 to 0.20 μm range when the penultimate coating includes a level of the pigment mixture that does not interfere with other desired properties of the penultimate coating. Generally, the penultimate coating formulation can contain about 50 to 90% of the pigment mixture, preferably about 60 to 85%, without deleteriously affecting other properties of the penultimate coating.

The penultimate coating will contain an amount of the pigment mixture that is sufficient to provide desired ink setting and ink drying rates. The amount of the pigment mixture used will depend in part on the level of HIP filler used (as discussed above) as well as the desired characteristics of the paper.

Using a mixture of pigments allows the overall particle size distribution of the mixture to be easily varied, by selecting of the size, shape, aspect ratio and particle size distribution of each pigment and the relative proportions of the pigments in the mixture. However, a single pigment that has been particle size modified to have the desired overall particle size distribution may be used. Generally, it is preferred that the mix of pigments, or single pigment if only one is used, have a particle size distribution such that about 25% of the particles are finer than 0.2 μm, about 50% of the particles are finer than 0.5 μm, and about 70% of the particles are finer than 2 μm.

Suitable pigments include pigments that are typically used in paper coatings to impart printability and aesthetic properties to the paper, such as calcium carbonate, clays, titanium dioxide and plastic pigments. Preferred calcium carbonates are commercially available from Omya, Inc., Proctor, Vt., under the tradename HYDROCARB. Preferred clays include ASTRASHEEN clay, from Imerys Clays, Inc., Sandersville, Ga., and HYDRAGLOSS 90 clay, from J. M. Huber, Macon, Ga.

The chemical reactivity of the penultimate coating with the ink vehicle, resulting in chemically driven absorption of the ink vehicle (factor (3) discussed above), can be enhanced by including binders and/or other additives that have a solubility parameter similar to that of the ink vehicle and that react quickly with the ink vehicle to swell and absorb the vehicle. The solubility parameters of typical thin ink vehicle Magic oils are well known in the art. Generally, to match the solubility parameter of Magic oils, the latex binder of the penultimate coating should have a solubility parameter (Sp) in the range of 7.0-8.0 (cal/cm³)^{0.5}. The ink vehicle interactivity of a binder, or other ink vehicle-interactive ingredient of the penultimate coating, can be determined based on the Lodcel ink interactivity performance of the binder or other ingredient. (Latex Binder Modification To Reduce Coating Pick on Six-Color Offset Presses; Ron Van Gilder & Roger Purfeerst, May 1994 TAPPI Journal, pages 230-239.) Suitable binders include latices of styrene-butadiene copolymers, styrene-butadiene acrylonitrile terpolymers, polyvinyl acetate, styrene acrylic, styrene acrylate, polyisoprene, polybutadiene, polyethylene and polyisobutylene. The binder may be used in any amount which will provide the coating with desired physical properties, e.g., about 5 to 30%.

If a sufficient amount of the HIP filler is used, and/or the penultimate coating has a sufficiently fine external peak mean pore diameter, the binder and other components of the penultimate coating may have relatively low ink interactivity. If the penultimate coating composition includes ingredients that have particularly low ink vehicle interactivity, it is generally preferred that the latex binder have a relatively high ink vehicle interactivity, to maintain the overall ink vehicle interactivity that is desired.

It is generally preferred that the majority, and preferably all, of the ink vehicle stay in the penultimate coating, rather than penetrating through the penultimate coating into the basesheet layer or through the thickness of the paper. Vehicle penetration may be controlled by adjusting the thickness and pore structure of the penultimate coating relative to the topcoat weight. It is generally preferred that the penultimate coating have a thickness of about 3 to 10 μm, which generally corresponds to a coat weight of about 5 to 20 g/m². The topcoat weight is generally in the range of about 6 to 20 g/m².

In some implementations, the penultimate coating includes the ingredients discussed above in the following proportions: from about 0 to 40%, preferably about from 10 to 20%, of the coarse pigment; from about 10 to 60%, preferably about 15 to 30%, of the fine pigment; about 20 to 100%, preferably about 30 to 60% of the ultrafine pigment; from about 3 to 20%, preferably about 6 to 12% of the HIP filler; and about 4 to 12%, preferably about 4 to 8% of the latex. The coating may also include from about 0 to 15% starch, if desired.

The properties of the topcoat are also significant in optimizing the printability properties of the paper, such as ink gloss, mottle, and ink film uniformity. The thickness and ink interactivity of the topcoat will impact how rapidly the ink vehicle drains through this layer. The speed at which the vehicle drains through the topcoat will determine how long the ink has to level and develop ink gloss, gain maximum ink film uniformity and minimize print mottle, and then how rapidly the penultimate coating must set and dry the ink. The topcoat should be formulated to act as a porous screen through which the ink vehicle can readily pass at a controlled rate while keeping the ink resins and pigments on the surface in order to level the ink and thereby improve the trade-off between ink drying and printability.

If a thick and relatively low porosity topcoat with low capillarity is used, the three factors discussed above should generally be adjusted upward (e.g., more HIP filler and/or finer external pigment pore structure with the attendant fine peak mean pore diameter and/or higher chemical ink interactivity.) This will allow the penultimate coating to quickly set and dry the ink once the ink vehicle penetrates through the topcoat to the penultimate coating.

To achieve the proper rate of draining of the ink vehicle through the topcoat, it is generally preferred that the topcoat include a pigment mixture (or single pigment having the desired average particle size and particle size distribution) that will provide the topcoat with a very fine external peak mean pore diameter, e.g., finer than 0.12 μm, preferably finer than 0.1 μm, for example between 0.05 and 0.08 μm, allowing it to act as a porous screen because of its capillarity. A suitable pigment mixture for this purpose includes the ultrafine and fine pigments discussed above. The coarse pigment is omitted. The topcoat also generally includes a particle size distribution (PSD) modified clay, i.e., a clay that has been modified such that its amounts of fines are reduced so that less than 25% of the particles are finer than 0.2 μm and there is an abundance of particles in the 1 to 4 μm size range. For example, at least 10%, preferably at least 15%, and most preferably at least 20% of the particles can be in the 1 to 4 μm size range. Preferably these larger particles are in the form of flat platelets, enhancing the ink gloss and reducing the mottle exhibited by the printed ink. The low proportion of fines in the PSD modified clay allows the overall proportion of fines in the pigment mixture to be easily adjusted using the fine and ultrafine pigments. Suitable clays include those commercially available from Imerys Clays, Inc., under the tradenames ALPHA-PRINT 100 and CAPIM DG. The topcoat preferably includes a pigment or pigment blend having an overall particle size distribution such that about 20% of the particles are finer than 0.2 μm, about 60% of the particles are finer than 0.5 μm, and 95% of the particles are finer than 2 μm. The pigment mixture may include, for example, from 10 to 60% of the ultrafine pigment, from 0 to 75% of the fine pigment, and 0 to 75% of the PSD modified clay based on the total weight of the pigment mixture.

While it is desirable for the ink vehicle to pass rapidly through the topcoat, fast draining of ink resin and pigments through the topcoat can result in low ink gloss and poor printability. Thus, the ink drainage and the ink gloss are controlled to a large extent by the topcoat. As discussed above, the pores of the topcoat are small enough to prevent ink resin and pigment penetration into the topcoat, while allowing the ink vehicle to be drawn through the topcoat into the penultimate coating at a controlled rate which delays the ink vehicle penetration long enough to allow proper ink leveling to obtain high ink gloss and good printability. Thus, the topcoat initially delays the ink drainage (passage of ink vehicle through the topcoat), to allow the ink resin and pigments to level and form a flat uniform film that results in high ink gloss with little print mottle or backtrap mottle. When the ink vehicle reaches the topcoat/penultimate coating interface, the fluid dynamic potential of the penultimate coating then quickly pulls the ink vehicle from the topcoat to allow for fast setting and rapid drying. Thus, the penultimate coating shifts the phase boundary of the rapid ink vehicle absorption away from the ink/topcoat interlace, towards the topcoat/penultimate coating interface.

Because the topcoat serves as a porous screen, it is generally undesirable to include any components in this coating that would absorb the ink vehicle in an uncontrolled manner. It is generally also necessary to prevent the topcoat from absorbing ink resins and pigments. Thus, the topcoat does not include any of the HIP filler, or other highly absorbent materials. In some cases, the topcoat is substantially free of absorbent materials, i.e., materials that would absorb and retain the ink vehicle.

It is generally preferred that the topcoat have a thickness of 3 to 10 μm, corresponding to a coat weight of about 6 to 20 g/m². The thickness and mean peak pore diameter of the topcoat can be adjusted to suit a particular application by adjusting the vehicle transport properties of the penultimate coating.

In some implementations, the topcoat includes the ingredients discussed above in the following proportions: from about 0 to 75%, preferably about 20 to 50%, of the fine pigment; about 10 to 60%, preferably about 20 to 50% of the ultrafine pigment; from about 0 to 75%, preferably about 20 to 50% of a PSD modified clay pigment; and about 5 to 15%, preferably about 8 to 12% of the latex. The coating may also include from about 0.5 to 2% polyvinyl alcohol and 0 to 5% starch, if desired.

As mentioned above, the basesheet may include other, optional coating layers. For example, in some cases the basesheet includes one or more size-press layers or basecoat layers under the penultimate coating layer. Such coatings are well known in the paper industry. The properties of these layers generally will not significantly affect the ink setting or drying rates, or the printability attributes of the paper, since the ink vehicle preferably does not penetrate beyond the penultimate coating layer. However, if desired, the basecoat layer(s) can be formulated to have some absorbency properties, to supplement the ink vehicle absorption provided by the penultimate coating, especially if the penultimate coating layer is thin and its volume is not sufficient to hold the ink vehicle volume absorbed. If desired, the basecoat layer(s) can have a composition similar to or the same as that of the penultimate coating layer, so as to exhibit a desired degree of ink vehicle interactivity and ink vehicle absorption.

### EXAMPLE

An 118 g/m² groundwood-free basesheet with a furnish comprising 43% hardwood, 20% softwood, 37% coated broke was manufactured at 2160 m/min. The ash content of the basesheet was 13%. A penultimate coating was provided having the formulation shown in the table below:

| Penultimate Coating Components | Percentage by Weight (%) |
|---|---|
| HYDROCARB 60 (coarse pigment) | 17 |
| HYDROCARB 90 (fine pigment) | 17 |
| ASTRASHEEN clay (ultrafine pigment) | 42 |
| SILCRON G-650 (HIP filler) | 8 |
| PG 280 (starch) | 10 |
| Styrene butadiene latex (ink interactive latex) | 6 |

This penultimate coating formulation was applied to the basesheet on the same paper machine via metered size press at 9 g/m² per side and dried via gas fired hot air at a speed of 2160 m/min and a temperature of 450° F. A topcoat was provided on an off-machine coater having the formulation shown in the table below:

| Topcoat Components | Percentage by Weight (%) |
|---|---|
| ALBAGLOS S (fine pigment) | 27 |
| ASTRASHEEN clay (ultrafine pigment) | 31 |
| ALPHAPRINT 100 clay (PSD modified | 31 |
| pigment) | |
| Styrene butadiene acrylonitrile latex | 10 |
| (Non-ink interactive latex) | |
| Polyvinyl alcohol | 1.0 |

This topcoat formulation was applied to the penultimate coated basesheet at 9 g/m² on the feltside and 11 g/m² on the wireside via a bevel blade coater running at 2880 m/min and dried via gas fired hot air and dryer cans at a speed of 2880 m/min and a temperature of 400° F. to a reel moisture of 5.0%. The paper was then calendered on an OPTI-LOAD calendar running at 2520 m/min using a 280° F. surface temperature and 1400 p1i pressure for a glossy finish and a dull calendar for a dull finish.

A number of papers produced in this manner in various trials were tested, with the average results over the paper and print trials shown in the table below. Of the test results listed below, PPS, Gloss 75° & Tobias Microgloss are paper tests; the rest are print tests performed on press printed paper.

| Test Results | Gloss Finish | Dull Finish |
|---|---|---|
| PPS 10 kg Soft | 0.8 | 1.5 |
| Gloss 75° | 79 | 51 |
| Tobias Microgloss | 677 | 464 |
| 20° Gloss Magenta - Printer | 44 | 27 |
| 75° Gloss Magenta - Printer | | 71 |
| Ink Film Continuity - Printer | 319 | 397 |
| Backtrap Mottle - Printer | 247 | 174 |
| Ink Set Time (min) | 13 | 18 |
| Cutter Press 1 Hour Rating | Good | Good |
| Fogra Ink Drying 1 Hour Rating | Good | Good |

These test results demonstrate that papers made in this manner exhibit both excellent printability and rapid ink setting and drying.

A number of embodiments of the invention have been described. Nevertheless, it will be understood that various modifications may be made without departing from the spirit and scope of the invention. Accordingly, other embodiments are within the scope of the following claims.

What is claimed is:

1. A paper comprising:
a basesheet;
a penultimate coating layer; and
a porous topcoat disposed directly adjacent the penultimate coating layer and having a surface exposed to receive a printed image;
wherein the penultimate coating layer is configured to draw ink vehicle through the topcoat.

2. The paper of claim 1 wherein the penultimate coating includes a filler having a high internal pore volume.

3. The paper of claim 1 wherein the penultimate coating layer has an external pigment pore structure with a peak mean pore diameter finer than 0.20 μm.

4. The paper of claim 3 wherein the penultimate coating layer has an external pigment pore structure with a peak mean pore diameter finer than 0.10 μm.

5. The paper of claim 2 wherein the penultimate coating layer includes up to 30% of said filler.

6. The paper of claim 2 wherein the filler is selected from the group consisting of synthetic amorphous silica gels, synthetic calcium silicate, synthetic silicon dioxide, calcined clay, porous calcium carbonate, and mixtures thereof.

7. The paper of claim 2 wherein the filler comprises a particulate material that creates micro-spores in the coating by interaction of the particulate material with itself or other materials in the coating.

8. The paper of claim 2 wherein the filler has an internal pore volume of at least 0.8 ml/gram.

9. The paper of claim 1 wherein the penultimate coating layer comprises a pigment or pigment blend having an overall particle size distribution such that about 25% of the particles are finer than 0.2 μm, about 50% of the particles are finer than 0.5 μm, and about 70% of the particles are finer than 2 μm.

10. The paper of claim 9 wherein the penultimate coating layer comprises a blend of pigments having different particle size distributions, the pigments being selected and provided in relative proportions so as to provide the overall particle size distribution.

11. The paper of claim 1 wherein the penultimate coating layer includes a component having high ink vehicle interactivity.

12. The paper of claim 1 wherein the topcoat comprises a pigment or pigment blend having an overall particle size distribution such that about 20% of the particles are finer than 0.2 μm, about 60% of the particles are finer than 0.5 μm, and 95% of the particles are finer than 2 μm.

13. The paper of claim 12 wherein the topcoat comprises a blend of pigments having different particle size distributions, the pigments being selected and provided in relative proportions so as to provide the overall particle size distribution.

14. The paper of claim 1 wherein the topcoat has an external pigment pore structure with a peak mean pore diameter finer than about 0.12 μm.

15. The paper of claim 14 wherein the topcoat has an external pigment pore structure with a peak mean pore diameter finer than about 0.10 μm.

16. The paper of claim 1 wherein the topcoat is substantially free of absorbent materials.

17. A paper comprising:
a basesheet;
a penultimate coating layer comprising (a) a filler having a high internal pore volume; and (b) a pigment or pigment blend having an overall particle size distribution such that about 25% of the particles are finer than 0.2 μm, about 50% of the particles are finer than 0.5 μm, and about 70% of the particles are finer than 2 μm; and
a porous topcoat, disposed directly adjacent the penultimate coating layer and having a surface exposed to receive a printed image.

18. The paper of claim 17 wherein the penultimate coating further comprises a component having high ink vehicle interactivity.

19. The paper of claim 17 wherein the penultimate coating layer has an external pigment pore structure with a peak mean pore diameter finer than 0.20 μm.

20. The paper of claim 17 wherein the topcoat has an external pigment pore structure with a peak mean pore diameter finer than about 0.12 μm.

21. The paper of claim 20 wherein the topcoat has an external pigment pore structure with a peak mean pore diameter finer than about 0.10 μm.

22. The paper of claim 17 wherein the topcoat is substantially free of absorbent materials.
